(19) United States
(12) Patent Application Publication
(10) Pub. No.: US 2020/0394576 A1
(43) Pub. Date: Dec. 17, 2020

(54) Machine Learning-Enabled Event Tree for Rapid and Accurate Customer Problem Resolution

(71) Applicant: AT&T Intellectual Property I, L.P., Atlanta, GA (US)

(72) Inventors: James W. Fan, San Ramon, CA (US); Alireza Hooshiari, Alpharetta, GA (US); Dan Celenti, Holmdel, NJ (US); Eric Forbes, Canton, GA (US)

(73) Assignee: AT&T Intellectual Property I, L.P., Atlanta, GA (US)

(21) Appl. No.: 16/437,074

(22) Filed: Jun. 11, 2019

(51) Int. Cl. G06Q 10/06; G06N 20/00

(52) U.S. Cl. CPC G06Q 10/067; G06N 20/00

(57) ABSTRACT

Concepts and technologies disclosed herein are directed to a machine learning-enabled event tree (“MLET”) for rapid and accurate customer problem resolution. According to one aspect disclosed herein, a designer system can receive a customer problem to be modeled. The designer system can create, based upon input from a designer, a plurality of levels and a plurality of nodes for an MLET to be used to resolve the customer problem. The designer system can create, further based upon the input, a plurality of Boolean logic gates between the plurality of levels of the MLET. The designer system can obtain a plurality of machine learning models and, further based upon the input, can create a navigation controller to link the plurality of machine learning models to the plurality of nodes in the MLET. The designer system can save the MLET for the customer problem.

### BACKGROUND

Service providers use business process management workflow engines to automate customer service problem resolution processes. Traditionally, workflow-based, troubleshooting applications integrate diagnostic functionality with a capability of initiating corrective action. These engines typically provide orchestration and coordination functionality of end-to-end problem resolution processes; however, the performance of these engines is hindered by several shortcomings. In particular, the diagnostic process is based on a linear and sequential implementation of a trial-and-error methodology resulting in an unnecessarily lengthy process responsible for a high percentage of inaccurate solutions and consequently, many repeat calls (or other contact) from dissatisfied customers because the problem is not solved in a timely manner or not solved at all. In a best case scenario, a sequential, step-by-step problem resolution process can unify the approach of solving common problems by different customer service agents. Often times this process triggers a high number of clarifying requests generated by the business process manager, thus increasing the handling and overall resolution time, with a negative impact on customer experience and operating costs. The business process manager is primarily designed to handle reactive/interactive care. As a result, to address the need of proactive care, most service providers have to rely on a separate diagnostics platform. High operating cost (e.g., due to high number of initial and repeat calls, dispatches, etc.) also hinder performance of these engines.

Some companies use an event/fault tree approach to make the workflow solutions more structured. While the typical event/fault trees used to mitigate the above issues also simplify the flow development process, these event/fault trees are developed based upon historical data. This is a rigid approach that leaves no room for real-time adjustments of paths used by customer service agents to traverse the event/fault tree to determine the corrective action(s) to be taken.

### SUMMARY

Concepts and technologies disclosed herein are directed to aspects of machine learning-enabled event trees (“MLETs”) for rapid and accurate customer problem resolution. According to some aspects of the concepts and technologies disclosed herein, a designer system can receive a customer problem to be modeled. The customer problem can be associated with a service provided by a service provider to a customer, a customer device associated with the customer, or a network utilized by the customer. Other customer problems are contemplated. The designer system can create, based upon input from a designer, a plurality of levels and a plurality of nodes for an MLET to be used to resolve the customer problem. The designer system can create, further based upon the input, a plurality of Boolean logic gates between the plurality of levels of the MLET. The designer system can obtain a plurality of machine learning models and, further based upon the input, can create a navigation controller to link the plurality of machine learning models to the plurality of nodes in the MLET. The designer system can save the MLET for the customer problem.

In some embodiments, the plurality of nodes in the MLET can include a top event node indicative of the customer problem and one or more intermediate event nodes indicative of symptoms of the customer problem. The top event node and the intermediate event node(s) can be connected via Boolean logic gates (e.g., AND gates and/or OR gates). The plurality of nodes can additionally include a root cause of the customer problem.

In some embodiments, the navigation controller defines a plurality of navigation options to be used by a customer service agent to traverse the MLET. For example, the navigation options can include a level-by-level option to allow the customer service agent to traverse the MLET through the plurality of levels; a skip to level n option to allow the customer service agent to skip to level n and obtain a recommendation in that level; and a root cause option to skip directly to the root cause.

According to another aspect of the concepts and technologies disclosed herein, a customer service agent device can receive a customer problem. The customer service agent device can determine an MLET to be used to troubleshoot and resolve the customer problem. The MLET can include a plurality of levels and a plurality of nodes. At least one of the plurality of nodes can be linked to a machine learning model. The customer service agent device can present the MLET to a customer service agent. The customer service agent device can receive selection of a target node from the plurality of nodes in the MLET. The customer service agent device can present a navigation option for the target node. The navigation option, when selected, can cause execution of the machine learning model. The customer service agent device can present a recommendation to the customer service agent based upon an output of the machine learning model.

In some embodiments, the recommendation indicates a specific level of the plurality of levels to which the customer service agent should jump in a traversal of the MLET. In other embodiments, the recommendation indicates a specific node of the plurality of nodes to which the customer service agent should jump in a traversal of the machine learning-enabled event tree. In some embodiments, the recommendation indicates a root cause of the customer problem, and in these embodiments, the machine learning model is a monolithic machine learning model.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of illustrative operating environment for various concepts and technologies disclosed herein.

FIG. 2A is a diagram illustrating aspects of an example logical structure and topology for an example machine learning-enabled event tree (“MLET”), according to an illustrative embodiment of the concepts and technologies disclosed herein.

FIG. 2B is a diagram illustrating aspects of another example logical structure and topology for an example MLET, according to an illustrative embodiment of the concepts and technologies disclosed herein.

FIG. 3 is a flow diagram illustrating aspects of a method for creating an MLET, according to an illustrative embodiment of the concepts and technologies disclosed herein.

FIG. 4 is a flow diagram illustrating aspects of a method for a runtime execution of an MLET, according to an illustrative embodiment of the concepts and technologies disclosed herein.

FIG. 5 is a block diagram illustrating an example computer system, according to some illustrative embodiments.

FIG. 6 is a block diagram illustrating an example mobile device, according to some illustrative embodiments.

FIG. 7 schematically illustrates a network, according to an illustrative embodiment.

FIG. 8 is a block diagram illustrating a cloud computing platform capable of implementing aspects of the concepts and technologies disclosed herein.

FIG. 9 is a block diagram illustrating a machine learning system capable of implementing aspects of the concept and technologies disclosed herein.

### DETAILED DESCRIPTION

Customer service agents in many industries use event/fault trees (hereinafter “event trees”) to troubleshoot customer problems and to determine the appropriate corrective action(s) to be taken to mitigate or eliminate the customer problem. A common event tree topology uses Boolean logic coupled with historic data to add a probability to each node in the event tree. A problem with this approach is that some nodes can be misassigned with a probability indicative of low likelihood of occurrence, which can result in the customer service agent ignoring those nodes during the troubleshooting stage, and thereby misdiagnosing the customer's problem.

In an effort to manage the aforementioned problem, some companies have chosen to use a sophisticated machine learning neural network coupled with training dataset(s) to derive a single recommendation. This approach, while faster, suffers credibility since the machine learning-based recommendation may contradict the recommendation determined by the customer service agent. As a result, machine learning-based recommendations have not been widely accepted.

The concepts and technologies disclosed herein provide a hybrid model to maximize the benefits of both human-based and machine learning-based approaches. In particular, the concepts and technologies disclosed herein use event tree and machine learning to validate recommendations from each other and to provide a visualization method for customer service agents to navigate through and to perceive what is really happening. The customer service agents can intervene in the decision path if he/she desires.

A machine learning-enabled event tree (“MLET”) is described herein. An MLET is a breakthrough in problem resolution scheming to improve customer experiences, thereby reducing operational expenditures for companies. The MLET is based upon a model of a customer problem as an event tree based upon Boolean logic to determine the root cause of the customer problem rapidly and with increased accuracy. The MLET introduces an automation algorithm based upon machine learning to empower and enable customer service agents, technicians, and customers to follow a simple and manageable troubleshooting process.

Instead of a lengthy interaction with customers when they call, message, or otherwise contact a customer service agent, an event tree can be developed and solved for major customer contact drivers that point to one or more primary events of a customer's inquiry into a problem. By concentrating on primary events that point to potential root causes, troubleshooting time can be substantially reduced, thereby making troubleshooting effortless for customer service agents, technicians, and customers. The MLET can remove variability in customer and customer service agent troubleshooting decision making to improve accuracy and first call resolution (“FCR”), and therefore positively impacting net promoter scores (“NPSs”).

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

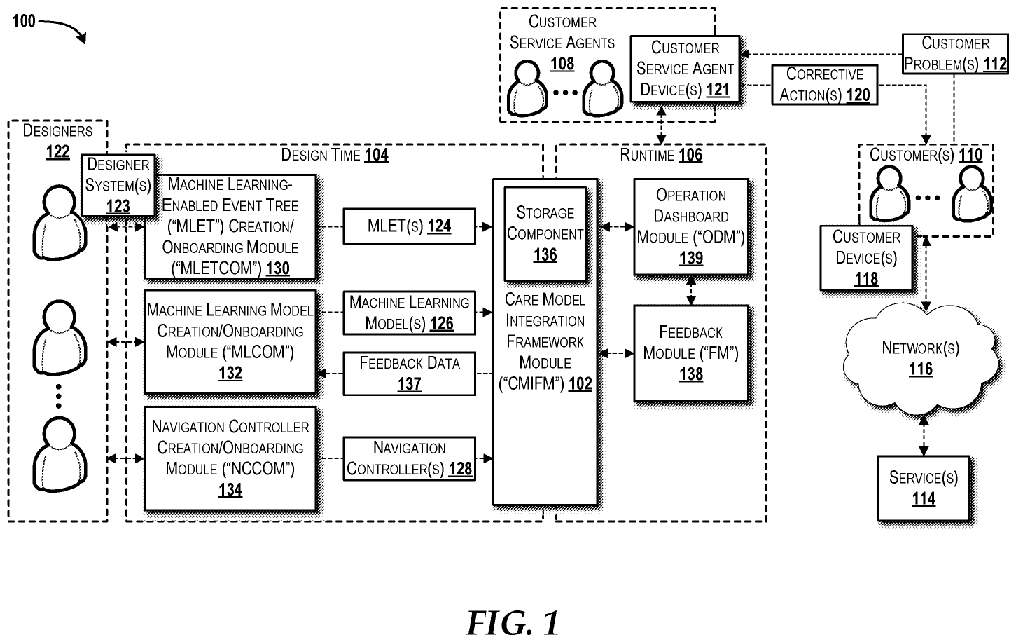

Turning now to FIG. 1, an operating environment 100 in which embodiments of the concepts and technologies disclosed herein will be described. The illustrated operating environment 100 includes a care model integration framework module (“CMIFM”) 102 that supports design time 104 and runtime 106 operations to assist one or more customer service agents 108 (hereinafter referred to individually as “customer service agent 108”, or collectively as “customer service agents 108”), one or more customers 110 (hereinafter referred to individually as “customer 110”, or collectively as “customers 110”), and/or one or more technicians or other human individuals (not shown) in troubleshooting and resolving one or more customer problems 112 (hereinafter referred to individually as “customer problem 112”, or collectively as “customer problems 112”) experienced by the customer(s) 110 with regard to one or more services 114 (hereinafter referred to individually as “service 114”, or collectively as “services 114”), one or more networks 116 (hereinafter referred to individually as “network 116”, or collectively as “networks 116”), and/or one or more customer devices 118 (hereinafter referred to individually as “customer device 118”, or collectively as “customer devices 118”).

The customer service agents 108 may be human agents that work with the customers 110 to troubleshoot and resolve the customer problems 112. The customer service agents 108 may be associated with one or more entities (e.g., company, enterprise, non-profit organization, charity organization, government entity, public/private school, childcare facility, University/college, and/or the like) that provide the service(s) 114, the network(s) 116, and/or the customer device(s) 118. The customer service agents 108 may be employees of one or more of the entities, contractors for one or more of the entities, or volunteers for one or more of the entities.

The customers 110 may be human customers that utilize the service(s) 114, the networks 116, and/or the customer device(s) 118. During use of the service(s) 114, the network(s) 116, and/or the customer device(s) 118, the customers 110 may experience the customer problem(s) 112 that prompt the customers 110 to contact the customer service agents 108 for a resolution to the customer problem(s) 112 via one or more corrective actions 120 (hereinafter referred to individually as “corrective action 120”, or collectively as “corrective actions 120”). The customer problems 112 can include any problems the customers 110 have with the service(s) 114, the network(s) 116, and/or the customer device(s) 118. The customer problems 112 can generally include customer experience problems, service availability problems, service degradation problems, service performance problems, customer device software problems, customer device firmware problems, customer device hardware problems, customer device performance problems, combinations thereof, and the like. The corrective actions 120 can generally include any action taken by the customer service agents 108, or taken by the customers 110 at the direction of the customer service agents 108, to resolve, at least in part, the customer problems 112. It should be understood that the specific details of a given customer problem 112 can vary widely depending upon multiple factors, and as such, it is impossible to disclose every possible combination of factors that results in a given customer problem 112. Likewise the specific details of a given corrective action 120 can vary widely depending upon the specific details of a given customer problem 112. For this reason, the specific examples of the customer problems 112 disclosed herein are merely exemplary of some customer problems that the concepts and technologies disclosed herein can be used to resolve, and as such, should not be construed as being limiting in any way.

The services 114 may be any service used by the customer(s) 110, including both paid and free services. By way of example, and not limitation, the service(s) 114 can include telecommunications services, Internet services, television services, utility services, information technology services, professional services, medical services, financial services, combinations thereof, and the like. Those skilled in the art will appreciate the applicability of the concepts and technologies disclosed herein to any type of service. Accordingly, any example services described herein should not be construed as limiting in any way.

The networks 116 may be or may include any wired, wireless, or hybrid network utilizing any existing or future network technology. The networks 116 can be or can include telecommunications networks, the Internet, other packet data networks, any other network disclosed herein, combinations thereof, and the like. The networks 116 can include private networks and/or public networks. The networks 116 can include local area networks (“LANs”), wide area networks (“WANs”), personal area networks (“PANs”), metropolitan area networks (“MANs”), other area networks, combinations thereof, and the like. In some embodiments, the networks 116 include one or more mobile telecommunications networks that utilize any wireless communications technology or combination of wireless communications technologies such as, but not limited to, WI-FI, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. Embodied as a mobile telecommunications network, the networks 116 can support various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data described herein can be exchanged over the mobile telecommunications network via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. The mobile telecommunications network can be improved or otherwise evolve to accommodate changes in industry standard, such as to adhere to generational shifts in mobile telecommunications technologies, such as is colloquially known as 4G, 5G, etc. As such, the example technologies described herein should not be construed as limiting in any way.

The customer devices 118 can communicate, via the network(s) 116, with each other, the service(s) 114, the CMIFM 102, one or more customer service agent devices 121 (hereinafter referred to individually as “customer service agent device 121”, or collectively as “customer service agent devices 121”), the customer service agents 108, other devices, other systems, other networks, combinations thereof, and the like. According to various embodiments, the functionality of the customer devices 118 can be provided by one or more mobile telephones, smartphones, tablet computers, slate computers, smart watches, fitness devices, smart glasses, other wearable devices, mobile media playback devices, set top devices, router devices, switch devices, gateway devices (e.g., residential gateway devices), navigation devices, laptop computers, notebook computers, ultrabook computers, netbook computers, server computers, computers of other form factors, computing devices of other form factors, other computing systems, other computing devices, Internet of Things (“IoT”) devices, other unmanaged devices, other managed devices, and/or the like. It should be understood that the functionality of the customer devices 118 can be provided by a single device, by two or more similar devices, and/or by two or more dissimilar devices.

The functionality of the customer service agent devices 121 can be provided by one or more mobile telephones, smartphones, tablet computers, slate computers, laptop computers, notebook computers, ultrabook computers, netbook computers, server computers, computers of other form factors, computing devices of other form factors, other computing systems, other computing devices, and/or the like. It should be understood that the functionality of the customer service agent devices 121 can be provided by a single device, by two or more similar devices, and/or by two or more dissimilar devices.

Returning to the CMIFM 102, during the design time 104, one or more model/controller designers (“designers”) 122 (hereinafter referred to individually as “designer 122”, or collectively as “designers 122”) can utilize one or more designer systems 123 to execute various software modules to design, build, and onboard one or more machine learning-enabled event trees (“MLETs”) 124 (hereinafter referred to individually as “MLET 124”, or collectively as “MLETs 124”), one or more machine learning models 126 (hereinafter referred to individually as “machine learning model 126”, or collectively as “machine learning models 126”), and one or more navigation controllers 128 (hereinafter referred to individually as “navigation controller 128”, or collectively as “navigation controllers 128”) to the CMIFM 102 in accordance with the concepts and technologies disclosed herein. In particular, the designers 122 can utilize an MLET creation/onboarding module (“MLETCOM”) 130 to design, build, and onboard the MLETs 124 to the CMIFM 102; the designers 122 can utilize a machine learning model creation/onboarding module (“MLCOM”) 132 to design, build, and onboard the machine learning models 126 to the CMIFM 102; and the designers 122 can utilize a navigation controller creation/onboarding module (“NCCOM”) 134 to design, build, and onboard the navigation controllers 128 to the CMIFM 102. The MLETs 124, the machine learning models 126, and the navigation controllers 128 can be stored in a storage component 136 associated with the CMIFM 102.

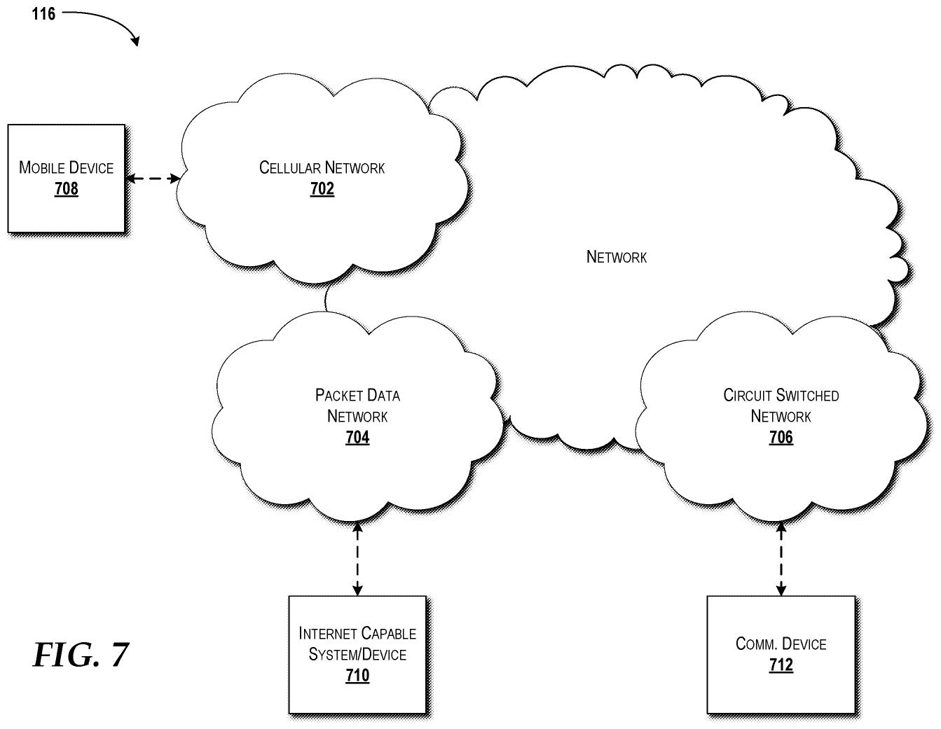

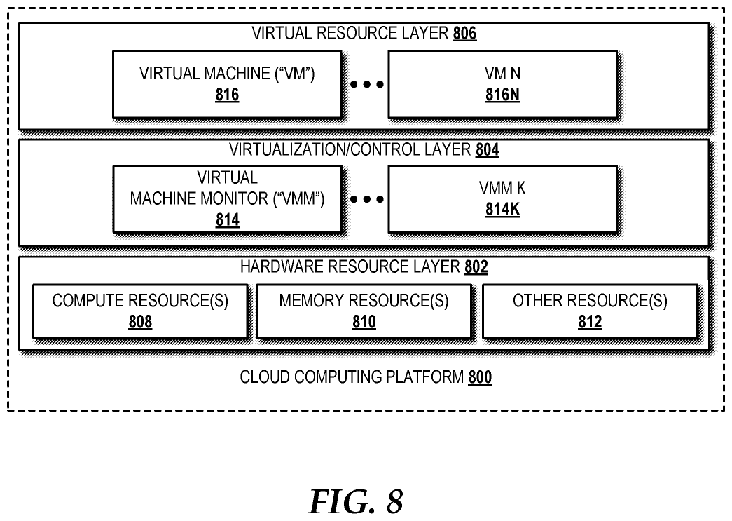

Although not shown in the illustrated embodiment, the designers 122 can utilize one or more devices (best shown in FIG. 7), one or more computer systems (best shown in FIG. 8) and/or one or more cloud computing platforms (best shown in FIG. 11) that execute, via one or more processors, instructions contained in the MLETCOM 130, the MLCOM 132, and the NCCOM 134, and stored in memory to facilitate designing, building, and onboarding the MLETs 124, the machine learning models 126, and the navigation controllers 128, respectively. Moreover, the MLETCOM 130, the MLCOM 132, and the NCCOM 134 can provide a user interface (e.g., a graphical user interface) through which the designers 122 can design, build, and onboard the MLETs 124, the machine learning models 126, and the navigation controllers 128. In some embodiments, the MLETCOM 130, the MLCOM 132, and/or the NCCOM 134 are provided as part of standalone, dedicated systems used by the designers 122 to design, build, and onboard the MLETs 124, the machine learning models 126, and the navigation controllers 128. In some other embodiments, two or more of the MLETCOM 130, the MLCOM 132, and/or the NCCOM 134 are combined, such as part of a design time application suite.

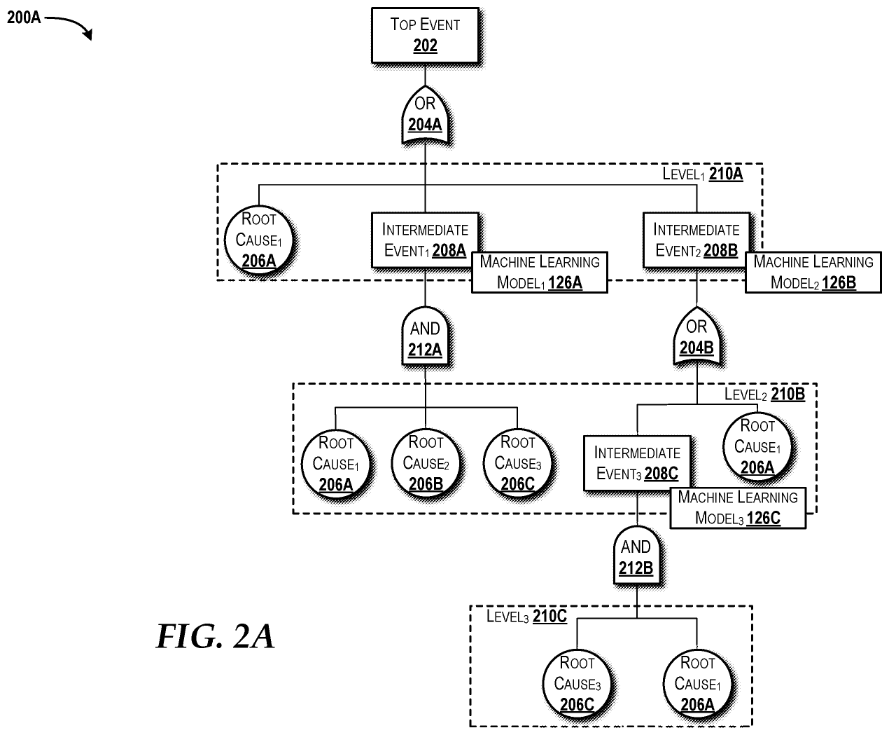

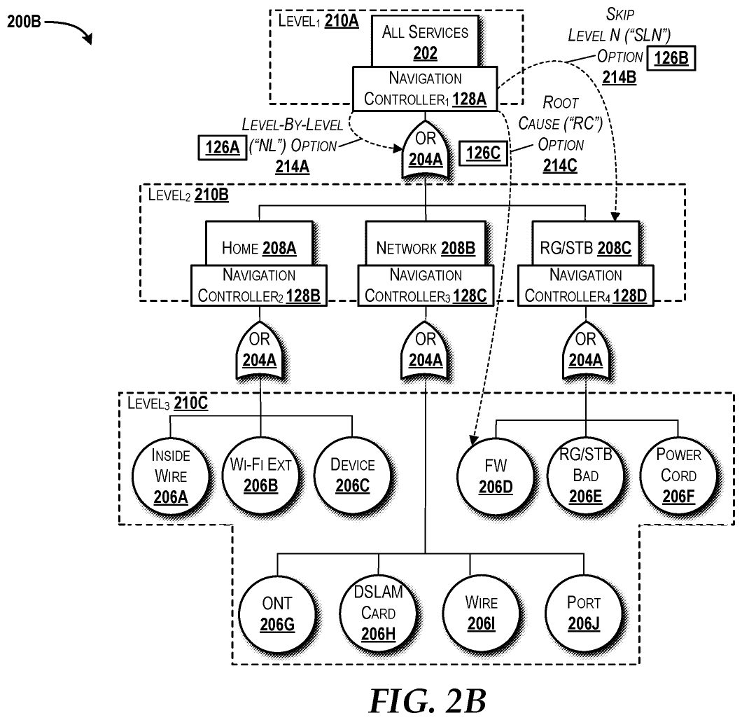

The MLETs 124 improve the efficiency and accuracy of diagnosing the customer problems 112 by augmenting event tree-based root cause methods with machine learning techniques. Current event tree methods use historical data to quantify the frequency of certain events and to calculate their probability of occurrence. The integration of machine learning with event trees is accomplished by assigning one or more of the machine learning models 126 to one or more event tree nodes, such as primary decision nodes, including a top event node and one or more intermediate event nodes, as will be described in greater detail below with reference to FIG. 2A.

One or more of the machine learning models 126 can be applied to each node in the MLET 124 to add intelligence and to optimize the decision-making process performed by the customer service agents 108 involved in traversing the MLET 124. The machine learning models 126 can be trained based upon historical data associated with resolving the customer problems 112 using, at least in part, a traditional event tree. Moreover, the machine learning models 126 can be re-trained over time based upon feedback data 137 obtained from a feedback module (“FM”) 138 during the runtime 106. The feedback data 137 can be provided directly by the customer service agents 108 and/or collected passively based upon output of the machine learning models 126. The output of the machine learning models 126 can be augmented with additional contextual data provided by the customer service agents 108 to improve the accuracy of the predictions made by the customer service agents 108.

The machine learning models 126 can be created by a machine learning system (best shown in FIG. 12) based upon one or more machine learning algorithms (also best shown in FIG. 12). The machine learning algorithms may be any existing algorithms, any proprietary algorithms, or any future machine learning algorithms. Some example machine learning algorithms include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of other machine learning algorithms not explicitly mentioned herein.

The customer service agents 108 have full control of the way in which various levels of machine learning are used. The navigation controllers 128 may be added to one or more nodes in the MLETs 124 to allow the customer service agents 108 to decide, based on their experience and latency requirements, how much their prediction should rely on the machine learning models 126. In some embodiments, the customer service agent 108 can use the navigation controller 128 at a top event node to select a monolithic machine learning model of the machine learning models 126 to replace the entirety of the MLET 124 under consideration. In other embodiments, the customer service agent 108 can use the navigation controller 128 at a top event node to select one or more of the machine learning model 126 to partially traverse the MLETs 124 and skip some steps via manual intervention by the customer service agent 108. In other embodiments, the machine learning model 126 can be used to navigate through each node while the customer service agent 108 is traversing the MLET 124. In this manner, the navigation controllers 128 provide an innovative control feature to one or more nodes in the MLET 124 that allows the customer service agents 108 to decide how the MLETs 124 should be traversed (e.g., level-by-level, sequentially, or by skipping some or all levels of the MLET 124) and to monitor and visualize the transactions. The navigation controllers 128 allow the customer service agents 108 to dynamically enable, disable, and adjust the level of machine learning involvement at each level of the MLETs 124. The customer service agents 108 are in full control of choosing a diagnostic path. As a result, the same problem experienced by different customers 110, or by the same customer 110 at a different time, may be diagnosed by traversing the MLET 124 following different paths. The outcome of the diagnostic process (i.e., the recommendation of the corrective action(s) 120) can be recorded along with the decision steps leading to the outcome and the associated contextual data.

During the runtime 106, the customer service agents 108 can utilize an operation dashboard module (“ODM”) 139 to visualize the state of the MLETs 124 and to traverse each level/node of the MLETs 124 to determine the root causes of the customer problems 112 and to determine the corrective actions 120 needed to resolve the customer problems 112. Regardless of how the customer service agents 108 choose to traverse the MLETs 124, the feedback data 137 can be collected and stored by the feedback module 138. The feedback module 138 can provide the feedback data 137 back to the MLCOM 132 so the MLCOM 132 can retrain the machine learning models 126 based upon the feedback data 137.

Turning now to FIG. 2A, an example logical structure and topology 200A for an example MLET 124 will be described, according to an illustrative embodiment. The example MLET 124 can be created by the designers 122 using the MLETCOM 130 for a particular one of the customer problems 112. The logical structure and topology 200A includes a top event (“top event”) 202 that is representative of a reason why the customer 110 made an inquiry to the customer service agent 108. The top event 202 can identify explicitly the customer problem 112. In the illustrated example, the top event 202 passes through an OR gate 204A to either a first root cause (“root cause₁”) 206A, a first intermediate event (“intermediate event”) 208A, or a second intermediate event (“intermediate event₂”) 208B in a first level (“level₁”) 210A of the MLET 124. An analysis of the MLET 124 at the level₁ 210A indicates that the root cause₁ 206A is the most probable cause of the customer problem 112. The customer service agent 108 could end his/her analysis at the level₁ 210A, or optionally, further analyze the intermediate events 208, which are representative of specific symptoms of the customer problem 112.

The intermediate events 208 can be analyzed further to uncover the root cause 206 of the top event 202. In the illustrated example, the intermediate event₁ 208A passes through an AND gate 212A to the root cause₁ 206A, a root cause₂ 206B, and a root cause₃ 206C in a second level (“level₂”) 210B of the MLET 124. The intermediate event₂ 208B passes through an OR gate 204B to a third intermediate event (“intermediate event₃”) 208C and the root cause₁ 206A in the level₂ 210B. An analysis of the MLET 124 at the level₂ 210B indicates again that the root cause₁ 206A is the most probable cause of the customer problem 112. The customer service agent 108 could end his/her analysis at the level₂ 210B, or optionally, further analyze the intermediate event₃ 208C. In the illustrated example, the intermediate event₃ 208C passes through an AND gate 212B to the root cause₁ 206A and the root cause₃ 206C in a third level (“level₃”) 210C of the MLET 124. An overall analysis of the MLET 124 reveals the root cause₁ 206A to be the most likely cause of the customer problem 112. The other root causes 206B, 206C may have contributed, at least in part, the customer problem 112, but determining the corrective action(s) 120 to address the root cause₁ 206A as the root cause of the customer problem 112 is most likely to yield a successful resolution.

The machine learning model(s) 126 can be applied at specific nodes in the MLET 124. In the illustrated example, a first machine learning model (“machine learning models”) 126A can be applied to the intermediate event₁ 208A and a second machine learning model (“machine learning model₂”) 126B can be applied to the intermediate event₂ 208B in the level₁ 210A. For the intermediate event₁ 208A, the machine learning model₁ 126A can be implemented at the discretion of the customer service agent 108 to predict the root causes₁₋₃ 206A-206C. For the intermediate event₂ 208B, the machine learning model₂ 126B can be implemented at the discretion of the customer service agent 108 to predict either the intermediate event₃ 208C or the root cause₁ 206A. By relying, at his/her discretion, on the machine learning models₁₋₂ 126A-126B instead of manual analysis, the MLET 124 can be traversed more efficiently to reach the root cause (i.e., the root cause 126A) of the customer problem 112 faster and with greater accuracy. In this manner, repeat calls, messages, or other contact from the customer 110 can be mitigated or eliminated with respect to this instance of the customer problem 112.

Turning now to FIG. 2B, another example logical structure and topology 200B for an example MLET 124 will be described, according to an illustrative embodiment. The concepts and technologies described herein enable the flexibility of controlling the level of machine learning being executed and the type of the machine learning models 126 being used in each level 210 of the MLET 124. When a problem occurs, the customer service agent 108 can be presented, via the ODM 139, at least three options for navigating the MLET 124 via the navigation controllers 128. In particular, a first navigation controller (“navigation controller₁ 128A”) associated with the top event 202 (Label: “all services”) in this example provides a level-by-level (“NL”) option 214A via the machine learning model₁ 126A to obtain a next level (i.e., the level₂ 210B) recommendation of one of the intermediate events 208A-208C (Labels: “home 208A”; “network 208B”; “residential gateway/set-top box (RG/STB)” 208C). The navigation controller₁ 128A associated with the top event 202 in this example also provides a skip-level n (“SLN”) option 214B via the machine learning model₂ 126B to skip to level n and obtain a recommendation in level n. In the illustrated example, the SLN option 214B is used to skip to the level₂ 210B and obtain a recommendation of the RG/STB 208C as the most probable source of the top event 202. The navigation controller₁ 128A associated with the top event 202 in this example also provides a root cause (“RC”) option 214C to skip all levels—using, for example, a monolithic machine learning model (illustrated as the machine learning model₃ 214C)—thereby establishing the root cause 206 illustrated at the bottom of the MLET 124 in the level₃ 210C as one or the root causes 206A-206J (Labels: “inside wire 206A”; “Wi-Fi extender (Wi-Fi Ext) 206B”; “device 206C”; “firmware (FW) 206D”; “RG/STB bad 206E”; “power cord 206F”; “optical network terminal (ONT) 206G”; “digital subscriber line access multiplexer (DSLAM) card 206H”; “wire 206I”; “port 206J”), and specifically, the FW 206D of the RG/STB.

An MLET level-by-level traversal example use case will now be described with reference to the logical structure and topology 200B for an example MLET 124. In this example, suppose a service provider provides the services 114, including a voice-over IP (“VoIP”) service, an Internet service, and a television service via a high-speed fiber network. A subsidiary of the service provider also offers 4G/5G data services augmented by a mobility voice service. The landline and mobile services are bundled and offered to the customers 110. When one of the customers 110 (hereinafter “customer 110”) calls a call center to report a customer problem 112 with his television service, the customer service agent 108 will be linked, via the ODM 139, to the MLET 124 to determine to which problem domain the customer problem 112 can be mapped. The machine learning model 126B at the top event 202 may already suggest the television service problem. During a conversation between the customer service agent 108 and the customer 110, it is determined that the problem domain of interest is indeed television problem, and in this case, sub-tree under with the top event (“all services”) 202 is mapped to the customer problem 112.

The customer service agent 108 can decide to use a level-by-level traversal method to identify the root cause 206 for the customer problem 112 by using the navigation controller₁ 128A, via the ODM 139, to turn the navigation control to the NL option 214A. The customer service agent 108 may have diagnostic tools to determine the next step. At the same time, the machine learning model₁ 126A associated with the NL option 214A can use available data collected during the interaction between the customer service agent 108 and the customer 110, as well as network diagnostic data from available diagnostic tools run by the customer service agent 108 or triggered by the machine learning model₁ 126A to make a prediction.

In the illustrated example, the machine learning model₁ 126A suggests to move to the RG/STB 208C after the home 208A and the network 208B connection problem possibilities are ruled out. The customer service agent 108 however, based on his past experience, may suspect a network problem as being the main cause. The customer service agent 108 can consider the machine learning recommendation of the RG/STB 208C and can decide to examine the history for a similar case, which might have been handled by a different one of the customer service agents 108. In this case, the recommendation made by the machine learning model₁ 126A may show at least a 95% accuracy, and therefore, the customer service agent 108 can decide to follow the recommendation and move to the RG/STB 208C sub-tree.

At the RG/STB 208C sub-tree, the customer service agent 108 again runs a few diagnostics while allowing the machine learning model₁ 126A to continue work in the background. The customer service agent 108 may notice that an STB log shows inconsistent results during the past few days and determines to settle on the root cause 206E (RG/STB bad) as the root cause 206 of the customer problem 112. The customer service agent 108 now takes a look at the recommendation made by the machine learning model₁ 126A. The machine learning model₁ 126A suggests that the root cause 206 is due to RG firmware incompatibility with an older STB video module which only happens during running a HD stream (i.e., the firmware 206D as the root cause 206). The customer service agent 108 can consider the history of the machine learning recommendation and takes notice of a 94% accuracy in prediction. The customer service agent 108 determines to settle on the firmware 206D as the root cause 206. The customer service agent 108 then initiates the corrective actions 120 to (1) trigger a firmware upgrade remotely for the customer device 118 (i.e., the RG), and (2) issue a ticket to send a new STB model to the customer 110. The machine learning recommendations in each level 210 of the MLET 124, along with any diagnostic data obtained by the customer service agent 108, can be logged for future analysis and provided to the MLCOM 132 as part of the feedback data 137 to re-train the machine learning model₁ 126A.

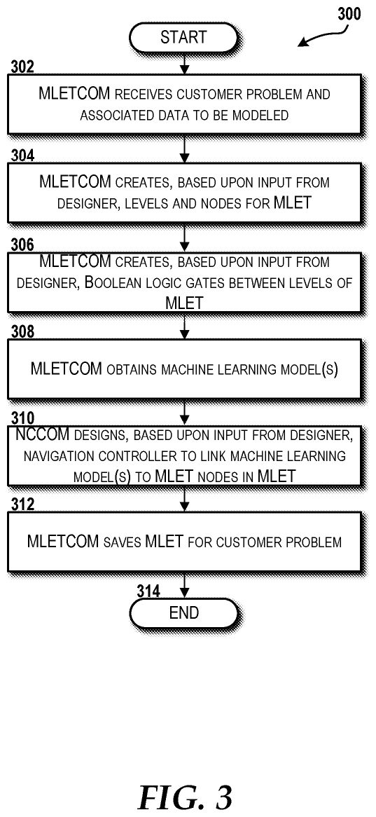

Turning now to FIG. 3, a flow diagram illustrating aspects of a method 300 for creating an MLET 124 will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed by alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described with reference to FIG. 3 and further reference to FIG. 1. The method 300 begins and proceeds to operation 302, where the designer system 123, executing the MLETCOM 130, receives the customer problem 112 and associated data to be modeled. In some embodiments, the customer service agents 108 can feed the customer problems 112 to the MLETCOM 130, which can queue the customer problems 112 for MLET modeling. The customer problem 112 data can include historic data and/or topology data associated with the service(s) 114, the network(s) 116, and/or the customer device(s) 118 to which the customer problem 112 pertains. From operation 302, the method 300 proceeds to operation 304, where the designer system 123, executing the MLETCOM 130, creates, based upon input from the designer(s) 122, the level(s) 210 and the MLET nodes, such as, for example, the top event(s) 202, the intermediate event(s) 208, and the root cause(s) 206. As noted above, the top event(s) 202 can identify a single fault or failure of the service(s) 114, the network(s) 116, and/or the customer device(s) 118; and the intermediate event(s) 208 can identify the symptom(s) of the single fault or failure identified by the top event(s) 202. From operation 304, the method 300 proceeds to operation 306, where the MLETCOM 130 creates, based upon input from the designer(s) 122, Boolean logic gates (e.g., the OR gates 204 and/or the AND gates 212) between the levels 210 and connects the top event(s) 202, the intermediate event(s) 208, and the root cause(s) 206.

From operation 306, the method 300 proceeds to operation 308, where the MLETCOM 130 obtains the machine learning model(s) 126 to be implemented at one or more of the MLET nodes in the MLET 124. From operation 308, the method 300 proceeds to operation 310, where the NCCOM 134 designs, based upon input from the designer(s) 122, the navigation controllers 128 used to link the machine learning model(s) 126 to the MLET nodes in the MLET 124. From operation 310, the method 300 proceeds to operation 312, where the MLETCOM 130 saves the MLET 124 for the customer problem 112. From operation 312, the method 200 proceeds to operation 314, where the method 300 ends.

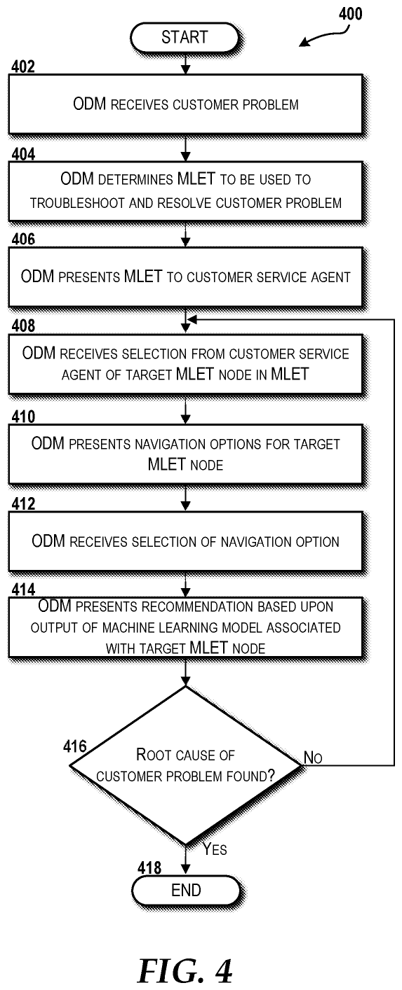

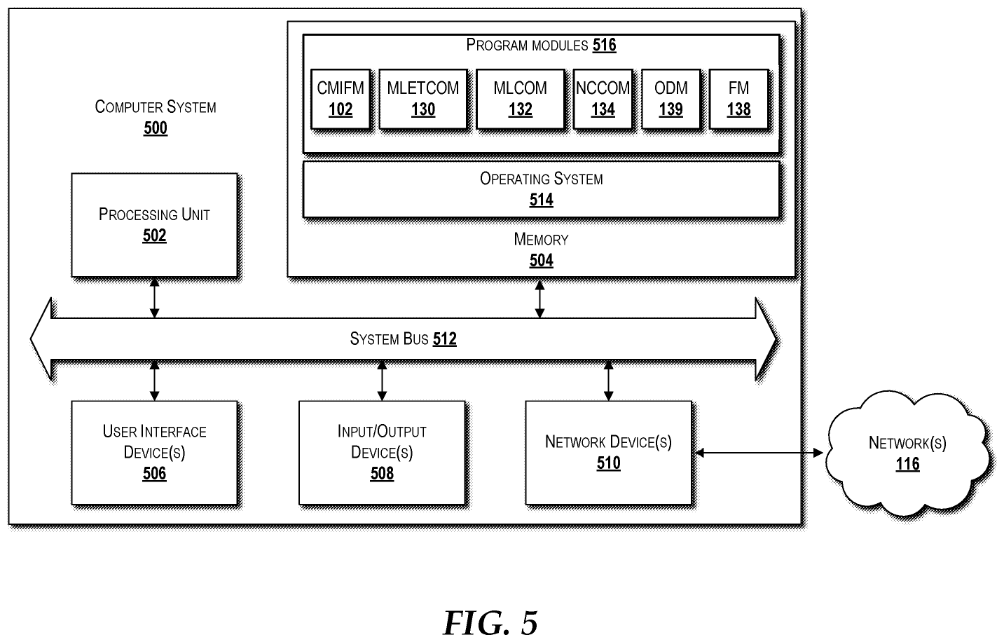

Turning now to FIG. 4, a method 400 for the runtime 106 execution of the MLET 124 will be described, according to an illustrative embodiment of the concepts and technologies disclosed herein. The method 400 will be described with reference to FIG. 4 and additional reference to FIG. 1. Moreover, the method 400 will be described from the perspective of the customer service agent 108 using the customer service agent device 121 to access the ODM 139. The ODM 139 may be installed on the customer service agent device 121. Alternatively, the ODM 139 may be installed on a server or other system (best shown in FIG. 5), a cloud computing platform (best shown in FIG. 8), or otherwise accessible by the ODM 139 to perform the operations described in the method 400.

The method 400 begins and proceeds to operation 402, where the ODM 139 receives the customer problem 112 from the customer service agent 108 via the customer service agent device 121. The customer problem 112 can be submitted to the customer service agent 108 via a telephone call, an email, a chat message, or some other contact method the customer 110 uses to report the customer problem 112 to the customer service agent 108. From operation 402, the method 400 proceeds to operation 404, where the ODM 139 determines the MLET 124 to be used to troubleshoot and resolve the customer problem 112. The ODM 139 can determine the MLET 124 based upon direct input provided by the customer service agent 108 if the customer service agent 108 is familiar with the customer problem 112. Alternatively, the ODM 139 can determine the MLET 124 based upon historical data, such as other customer problems 112 that exhibit similar symptoms. The ODM 139 may recommend the MLET 124 that was determined based upon historical data and provide the customer service agent 108 the opportunity to adopt the recommendation or proceed based on his/her own knowledge.

From operation 404, the method 400 proceeds to operation 406, where the ODM 139 presents the MLET 124 to the customer service agent 108 via the customer service agent device 121. As explained above, the MLET 124 presents the MLET nodes, including the top event(s) 202, the OR gate(s) 204, the root cause(s) 206, the intermediate event(s) 208, the level(s) 210, the AND gate(s) 212, or some combination thereof as a visual representation of the customer problem 112, any associated symptoms, and possible causes. From operation 406, the method 400 proceeds to operation 408, where the ODM 139 receives a selection from the customer service agent 108 of a target MLET node in the MLET 124.

From operation 408, the method 400 proceeds to operation 410, where the ODM 139 presents navigation options to the customer service agent 108 to allow the customer service agent 108 to decide how the MLET 124 should be traversed from the target MLET node. For example, the navigation options can include the NL option 214A, the SLN option 214B, and the RC option 214C described above with reference to FIG. 2B. As explained above with reference to FIG. 2B, the machine learning models 126 that are linked to one or more of the MLET nodes by the navigation controllers 128 can execute in the background to help guide the customer service agent 108 through the MLET 124. The customer service agent 108 does not need to adopt any particular recommendation made by the machine learning models 126, but, in doing so, the customer service agent 108 can reduce or eliminate false diagnoses, improve overall efficiency in handling the customer problem 112, and identify the correction action(s) 120 to be taken to resolve the customer problem 112 and potentially prevent further contact from the customer 110 with regard to the customer problem 112.

From operation 410, the method 400 proceeds to operation 412, where the ODM 139 receives a selection of one of the navigation options. From operation 412, the method 400 proceeds to operation 414, where the ODM 139 presents a recommendation to the customer service agent 108 based upon output of the machine learning model 126 associated with the target MLET node. From operation 414, the method 400 proceeds to operation 416, where it is determined whether the root cause 206 of the customer problem 112 has been found. For example, the customer service agent 108 might indicate the root cause 206 has been found either via the assistance of the machine learning model 126 and/or based upon the knowledge the customer service agent 108 has about the customer problem 112. In either case, the method 400 proceeds from operation 416 to operation 418, where the method 400 ends. If the root cause 206 of the customer problem 112 has not been found, the method 400 can return to the operation 408, where again the ODM 139 receives a selection from the customer service agent 108 of a target MLET node in the MLET 124 and the method 400 continues as describe above for the new target MLET node and any additional MLET nodes until the root cause 206 is found.

Turning now to FIG. 5, a block diagram illustrating a computer system 500 configured to provide the functionality described herein in accordance with various embodiments of the concepts and technologies disclosed herein. In some embodiments, the customer devices 118, the customer service agent devices 121, the designer systems 123, and/or other systems disclosed herein can be configured like and/or can have an architecture similar or identical to the computer system 500 described herein with respect to FIG. 5. It should be understood, however, any of these systems, devices, or elements may or may not include the functionality described herein with reference to FIG. 5.

The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the computer system 500.

The memory 504 communicates with the processing unit 502 via the system bus 512. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 516 may include various software and/or program modules described herein, such as the CMIFM 102, the MLETCOM 130, the MLCOM 132, the NCCOM 134, the ODM 139, and the FM 138. By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer to output data.

The network devices 510 enable the computer system 500 to communicate with other networks or remote systems via one or more networks, such as the network 135. Examples of the network devices 510 include, but are not limited to, a modem, a RF or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a WMAN such a WiMAX network, or a cellular network. Alternatively, the network(s) may be a wired network such as, but not limited to, a WAN such as the Internet, a LAN, a wired PAN, or a wired MAN.

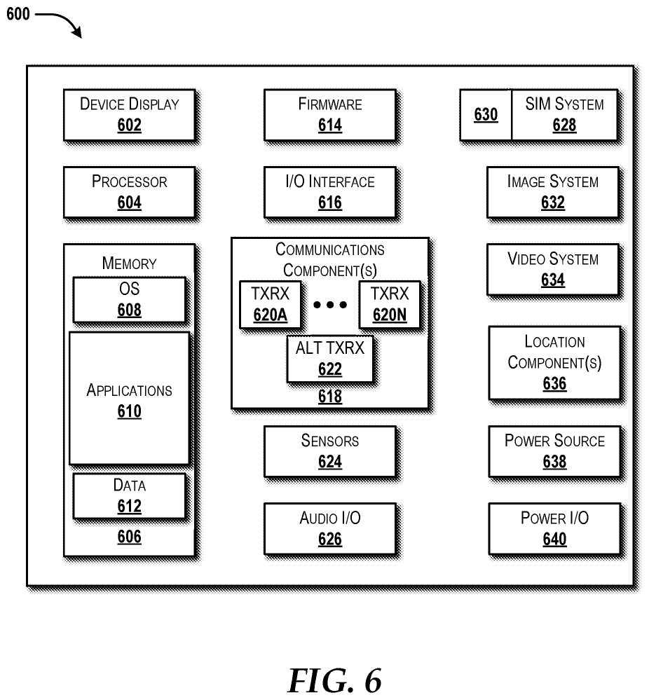

Turning now to FIG. 6, an illustrative mobile device 600 and components thereof will be described. In some embodiments, the customer devices 118, the customer service agent devices 121, and/or the designer systems 123 can be configured as and/or can have an architecture similar or identical to the mobile device 600 described herein with respect to FIG. 6. It should be understood, however, that the customer devices 118, the customer service agent devices 121, and/or the designer systems 123 may or may not include the functionality described herein with reference to FIG. 6. While connections are not shown between the various components illustrated in FIG. 6, it should be understood that some, none, or all of the components illustrated in FIG. 6 can be configured to interact with one other to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a device display 602 for displaying data. According to various embodiments, the device display 602 can be configured to display any information. The mobile device 600 also can include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in the memory 606, or the like. In some embodiments, the applications 610 also can include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in interacting with data. The UI application can be executed by the processor 604 to aid a user in answering/initiating calls, entering/deleting other data, entering and setting user IDs and passwords for device access, configuring settings, manipulating address book content and/or settings, multimode interaction, interacting with other applications 610, and otherwise facilitating user interaction with the operating system 608, the applications 610, and/or other types or instances of data 612 that can be stored at the mobile device 600.

According to various embodiments, the applications 610 can include, for example, a web browser application, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 610, the data 612, and/or portions thereof can be stored in the memory 606 and/or in a firmware 614, and can be executed by the processor 604. The firmware 614 also can store code for execution during device power up and power down operations. It should be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks, such as the network 143. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments one or more of the transceivers of the communications component 618 may be configured to communicate using GSM, CDMAONE, CDMA2000, LTE, and various other 2G, 2.5G, 3G, 4G, 5G and greater generation technology standards. Moreover, the communications component 618 may facilitate communications over various channel access methods (which may or may not be used by the aforementioned standards) including, but not limited to, TDMA, FDMA, W-CDMA, OFDM, SDMA, and the like.

In addition, the communications component 618 may facilitate data communications using GPRS, EDGE, the HSPA protocol family including HSDPA, EUL or otherwise termed HSDPA, HSPA+, and various other current and future wireless data access standards. In the illustrated embodiment, the communications component 618 can include a first transceiver (“TxRx”) 620A that can operate in a first communications mode (e.g., GSM). The communications component 618 also can include an N^{th} transceiver (“TxRx”) 620N that can operate in a second communications mode relative to the first transceiver 620A (e.g., UMTS). While two transceivers 620A-620N (hereinafter collectively and/or generically referred to as “transceivers 620”) are shown in FIG. 6, it should be appreciated that less than two, two, or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, BLE, infrared, infrared data association (“IRDA”), near field communications (“NFC”), other RF technologies, combinations thereof, and the like.

In some embodiments, the communications component 618 also can facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, orientation sensors, noise sensors, proximity sensors, or the like. As such, it should be understood that the sensors 624 can include, but are not limited to, accelerometers, magnetometers, gyroscopes, infrared sensors, noise sensors, microphones, combinations thereof, or the like. One or more of the sensors 624 can be used to detect movement of the mobile device 600. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, CCDs, combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another mobile device. The video and/or photo content also can be shared with other devices via various types of data transfers via wired and/or wireless communication devices as described herein.

The mobile device 600 also can include one or more location components 636. The location components 636 can be configured to send and/or receive signals to determine a specific location of the mobile device 600. According to various embodiments, the location components 636 can send and/or receive signals from GPS devices, A-GPS devices, WI-FI/WIMAX and/or cellular network triangulation data, combinations thereof, and the like. The location component 636 also can be configured to communicate with the communications component 618 to retrieve triangulation data from the network(s) 116 for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

Turning now to FIG. 7, additional details of an embodiment of the network 116 are illustrated, according to an illustrative embodiment. In the illustrated embodiment, the network 116 includes a cellular network 702, a packet data network 704, for example, the Internet, and a circuit switched network 706, for example, a publicly switched telephone network (“PSTN”). The cellular network 702 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the customer device 118, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSDPA), and HSPA+. The cellular network 702 also is compatible with 4G mobile communications standards as well as evolved and future mobile standards. In some embodiments, the network 116 can be configured like the cellular network 702.

The packet data network 704 can include various devices, for example, the customer devices 118, the customer service agent devices 121, the designer systems 123, servers, computers, databases, and other devices in communication with another. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet.

The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable systems/devices 710, for example, the customer devices 118, the customer service agent devices 121, the designer systems 123, a personal computer (“PC”), a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, the customer device 118, the customer service agent device 121, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. It should be appreciated that substantially all of the functionality described with reference to the network 116 can be performed by the cellular network 702, the packet data network 704, and/or the circuit switched network 706, alone or in combination with additional and/or alternative networks, network elements, and the like.

Turning now to FIG. 8, a cloud computing platform 800 capable of implementing aspects of the concepts and technologies disclosed herein will be described, according to an illustrative embodiment. In some embodiments, the customer devices 118, the customer service agent devices 121, the designer systems 123 can be implemented, at least in part, on the cloud computing platform 800. Those skilled in the art will appreciate that the illustrated cloud computing platform 800 is a simplification of but one possible implementation of an illustrative cloud computing environment, and as such, the cloud computing platform 800 should not be construed as limiting in any way.

The illustrated cloud computing platform 800 includes a hardware resource layer 802, a virtualization/control layer 804, and a virtual resource layer 806 that work together to perform operations as will be described in detail herein. While connections are shown between some of the components illustrated in FIG. 8, it should be understood that some, none, or all of the components illustrated in FIG. 8 can be configured to interact with one other to carry out various functions described herein. In some embodiments, the components are arranged so as to communicate via one or more networks (not shown). Thus, it should be understood that FIG. 8 and the following description are intended to provide a general understanding of a suitable environment in which various aspects of embodiments can be implemented, and should not be construed as being limiting in any way.

The hardware resource layer 802 provides hardware resources, which, in the illustrated embodiment, include one or more compute resources 808, one or more memory resources 810, and one or more other resources 812. The compute resource(s) 808 can include one or more hardware components that perform computations to process data, and/or to execute computer-executable instructions of one or more application programs, operating systems, and/or other software. The compute resources 808 can include one or more central processing units (“CPUs”) configured with one or more processing cores. The compute resources 808 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 808 can include one or more discrete GPUs. In some other embodiments, the compute resources 808 can include CPU and GPU components that are configured in accordance with a co-processing CPU/GPU computing model, wherein the sequential part of an application executes on the CPU and the computationally-intensive part is accelerated by the GPU. The compute resources 808 can include one or more system-on-chip (“SoC”) components along with one or more other components, including, for example, one or more of the memory resources 810, and/or one or more of the other resources 812. In some embodiments, the compute resources 808 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 808 can be or can include one or more hardware components architected in accordance with an ARM architecture, available for license from ARM HOLDINGS of Cambridge, United Kingdom. Alternatively, the compute resources 808 can be or can include one or more hardware components architected in accordance with an x86 architecture, such an architecture available from INTEL CORPORATION of Mountain View, Calif., and others. Those skilled in the art will appreciate the implementation of the compute resources 808 can utilize various computation architectures, and as such, the compute resources 808 should not be construed as being limited to any particular computation architecture or combination of computation architectures, including those explicitly disclosed herein.

The memory resource(s) 810 can include one or more hardware components that perform storage operations, including temporary or permanent storage operations. In some embodiments, the memory resource(s) 810 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 808.

The other resource(s) 812 can include any other hardware resources that can be utilized by the compute resources(s) 808 and/or the memory resource(s) 810 to perform operations described herein, such as with respect to the methods 300, 400. The other resource(s) 812 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resources layer 802 can be virtualized by one or more virtual machine monitors (“VMMs”) 814A-814K (also known as “hypervisors”; hereinafter “VMMs 814”) operating within the virtualization/control layer 804 to manage one or more virtual resources that reside in the virtual resource layer 806. The VMMs 814 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

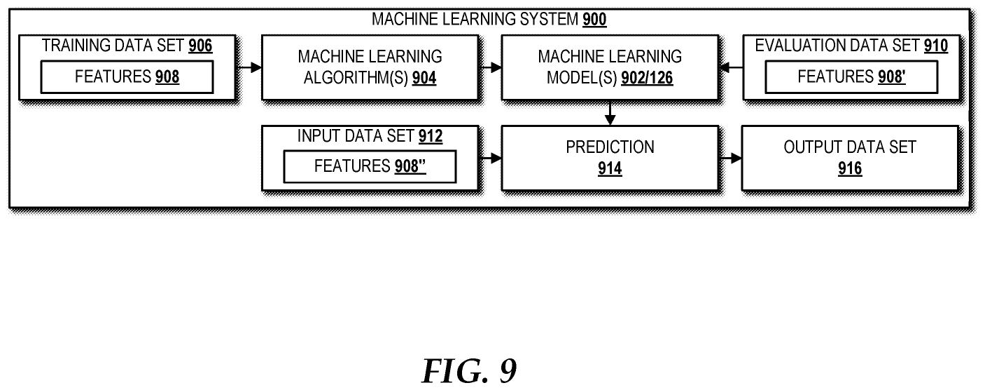

Turning now to FIG. 9, a machine learning system 900 capable of implementing aspects of the embodiments disclosed herein will be described. In some embodiments, the machine learning system 900 can be or can include the MLCOM 132. The illustrated machine learning system 900 includes one or more machine learning models 902, such as the machine learning models 126. The machine learning models 902 can include supervised and/or semi-supervised learning models. The machine learning model(s) 902 can be created by the machine learning system 900 based upon one or more machine learning algorithms 904. The machine learning algorithm(s) 904 can be any existing, well-known algorithm, any proprietary algorithms, or any future machine learning algorithm. Some example machine learning algorithms 904 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 904 based upon the problem(s) to be solved by machine learning via the machine learning system 900.

The machine learning system 900 can control the creation of the machine learning models 902 via one or more training parameters. In some embodiments, the training parameters are selected modelers at the direction of an enterprise, for example. Alternatively, in some embodiments, the training parameters are automatically selected based upon data provided in one or more training data sets 906. The training parameters can include, for example, a learning rate, a model size, a number of training passes, data shuffling, regularization, and/or other training parameters known to those skilled in the art. The training data in the training data sets 906 can be collected from the customer service agent devices 121, the feedback module 138, the MLCOM 132, the customers 110, the customer devices 118, the networks 116, the services 114, or any combination thereof.

The learning rate is a training parameter defined by a constant value. The learning rate affects the speed at which the machine learning algorithm 904 converges to the optimal weights. The machine learning algorithm 904 can update the weights for every data example included in the training data set 906. The size of an update is controlled by the learning rate. A learning rate that is too high might prevent the machine learning algorithm 904 from converging to the optimal weights. A learning rate that is too low might result in the machine learning algorithm 904 requiring multiple training passes to converge to the optimal weights.

The model size is regulated by the number of input features (“features”) 908 in the training data set 906. A greater the number of features 908 yields a greater number of possible patterns that can be determined from the training data set 906. The model size should be selected to balance the resources (e.g., compute, memory, storage, etc.) needed for training and the predictive power of the resultant machine learning model 902.

The number of training passes indicates the number of training passes that the machine learning algorithm 904 makes over the training data set 906 during the training process. The number of training passes can be adjusted based, for example, on the size of the training data set 906, with larger training data sets being exposed to fewer training passes in consideration of time and/or resource utilization. The effectiveness of the resultant machine learning model 902 can be increased by multiple training passes.

Data shuffling is a training parameter designed to prevent the machine learning algorithm 904 from reaching false optimal weights due to the order in which data contained in the training data set 906 is processed. For example, data provided in rows and columns might be analyzed first row, second row, third row, etc., and thus an optimal weight might be obtained well before a full range of data has been considered. By data shuffling, the data contained in the training data set 906 can be analyzed more thoroughly and mitigate bias in the resultant machine learning model 902.

Regularization is a training parameter that helps to prevent the machine learning model 902 from memorizing training data from the training data set 906. In other words, the machine learning model 902 fits the training data set 906, but the predictive performance of the machine learning model 902 is not acceptable. Regularization helps the machine learning system 900 avoid this overfitting/memorization problem by adjusting extreme weight values of the features 908. For example, a feature that has a small weight value relative to the weight values of the other features in the training data set 906 can be adjusted to zero.

The machine learning system 900 can determine model accuracy after training by using one or more evaluation data sets 910 containing the same features 908′ as the features 908 in the training data set 906. This also prevents the machine learning model 902 from simply memorizing the data contained in the training data set 906. The number of evaluation passes made by the machine learning system 900 can be regulated by a target model accuracy that, when reached, ends the evaluation process and the machine learning model 902 is considered ready for deployment.

After deployment, the machine learning model 902 can perform a prediction operation (“prediction”) 914 with an input data set 912 having the same features 908″ as the features 908 in the training data set 906 and the features 908′ of the evaluation data set 910. The results of the prediction 914 are included in an output data set 916 consisting of predicted data. The machine learning model 902 can perform other operations, such as regression, classification, and others. As such, the example illustrated in FIG. 9 should not be construed as being limiting in any way.

Based on the foregoing, it should be appreciated that aspects of MLETs for rapid and accurate customer problem resolution have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a designer system comprising a processor, a customer problem to be modeled;
creating, by the designer system, based upon input from a designer, a plurality of levels and a plurality of nodes for a machine learning-enabled event tree to be used to resolve the customer problem;
creating, by the designer system, based upon the input from the designer, a plurality of Boolean logic gates between the plurality of levels of the machine learning-enabled event tree;
obtaining, by the designer system, a plurality of machine learning models;
designing, by the designer system, based upon the input from the designer, a navigation controller to link the plurality of machine learning models to the plurality of nodes in the machine learning-enabled event tree; and
saving, by the designer system, the machine learning-enabled event tree for the customer problem.

2. The method of claim 1, wherein the customer problem is associated with a service provided by a service provider to a customer.

3. The method of claim 1, wherein the customer problem is associated with a customer device associated with a customer.

4. The method of claim 1, wherein the customer problem is associated with a network utilized by a customer.

5. The method of claim 1, wherein the plurality of nodes comprises a top event node indicative of the customer problem and an intermediate event node indicative of a symptom of the customer problem; and wherein the top event node and the intermediate event node are connected via a Boolean logic gate of the plurality of Boolean logic gates.

6. The method of claim 5, wherein the plurality of nodes further comprises a root cause of the customer problem.

7. The method of claim 6, wherein the navigation controller defines a plurality of navigation options to be used by a customer service agent to traverse the machine learning-enabled event tree.

8. A computer-readable storage medium comprising computer-executable instructions that, when executed by a processor, cause the processor to perform operations comprising:
receiving a customer problem to be modeled;
creating, based upon input from a designer, a plurality of levels and a plurality of nodes for a machine learning-enabled event tree to be used to resolve the customer problem;
creating, based upon the input from the designer, a plurality of Boolean logic gates between the plurality of levels of the machine learning-enabled event tree;
obtaining a plurality of machine learning models;
designing, based upon the input from the designer, a navigation controller to link the plurality of machine learning models to the plurality of nodes in the machine learning-enabled event tree; and
saving the machine learning-enabled event tree for the customer problem.

9. The computer-readable storage medium of claim 8, wherein the customer problem is associated with a service provided by a service provider to a customer.

10. The computer-readable storage medium of claim 8, wherein the customer problem is associated with a customer device associated with a customer.

11. The computer-readable storage medium of claim 8, wherein the customer problem is associated with a network utilized by a customer.

12. The computer-readable storage medium of claim 8, wherein the plurality of nodes comprises a top event node indicative of the customer problem and an intermediate event node indicative of a symptom of the customer problem; and wherein the top event node and the intermediate event node are connected via a Boolean logic gate of the plurality of Boolean logic gates.

13. The computer-readable storage medium of claim 12, wherein the plurality of nodes further comprises a root cause of the customer problem.

14. The computer-readable storage medium of claim 13, wherein the navigation controller defines a plurality of navigation options to be used by a customer service agent to traverse the machine learning-enabled event tree.

15. A method comprising:
receiving, by a customer service agent device comprising a processor, a customer problem;
determining, by the customer service agent device, a machine learning-enabled event tree to be used to troubleshoot and resolve the customer problem, wherein the machine learning-enabled event tree comprises a plurality of levels and a plurality of nodes, and wherein at least one of the plurality of nodes is linked to a machine learning model;
presenting, by the customer service agent device, the machine learning-enabled event tree to a customer service agent;
receiving, by the customer service agent device, selection of a target node from the plurality of nodes in the machine learning-enabled event tree; and
presenting, by the customer service agent device, a navigation option for the target node, wherein the navigation option, when selected, causes execution of the machine learning model.

16. The method of claim 15, further comprising receiving, by the customer service agent device, selection of the navigation option for the target node.

17. The method of claim 16, further comprising:
in response to receiving selection of the navigation option for the target node, causing the machine learning model to be executed; and
presenting a recommendation based upon an output of the machine learning model.

18. The method of claim 17, wherein the recommendation indicates a specific level of the plurality of levels to which the customer service agent should jump in a traversal of the machine learning-enabled event tree.

19. The method of claim 17, wherein the recommendation indicates a specific node of the plurality of nodes to which the customer service agent should jump in a traversal of the machine learning-enabled event tree.

20. The method of claim 17, wherein the recommendation indicates a root cause of the customer problem; and wherein the machine learning model comprises a monolithic machine learning model.
